(19) United States
(12) Patent Application Publication
(10) Pub. No.: US 2005/0175970 A1
(43) Pub. Date: Aug. 11, 2005

(54) Method and system for interactive teaching and practicing of language listening and speaking skills

(76) Inventors: David Dunlap, Carpenteria, CA (US); Derek M. Koch, Brooklyn, NY (US); Douglas P. Whetter, Santa Barbara, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/773,695

(22) Filed: Feb. 5, 2004

(51) Int. Cl. G09B 19/06

(52) U.S. Cl. 434/185; 434/169

(57) ABSTRACT

An interactive language instruction system employs a setting and characters with which a learner can interact with verbal and text communication. The learner moves through an environment simulating a cultural setting appropriate for the language being learned. Interaction with characters is determined by a skill level matrix to provide varying levels of difficulty. A visual dictionary allows querying of depicted objects in the environment for verbal and text definitions as well as testing for skill determination.

### FIELD OF THE INVENTION

This invention relates generally to the field of computer-aided instruction of languages, and more particularly to a method and system employing alterable interactive levels for teaching and practicing language listening and speaking skills.

### BACKGROUND OF THE INVENTION

Many business people, tourists, exchange students, and beginning language students need to develop a practical listening and speaking knowledge of the languages of countries they visit or study. Such casual language learners want to learn enough to accomplish successfully such missions as ordering a meal, buying a train ticket and getting help with a medical problem. They don't need to communicate perfectly or to speak like a native, but they must understand natives, and they must speak well enough to be understood. Furthermore, they must learn about local customs, especially those that differ from their own. Because their exposure to an unfamiliar language and environment might be imminent and brief, they want to learn the necessary language skills quickly and inexpensively. To feel comfortable with their new skills, they require both practice in realistic situations and objective, specific feedback from good listeners.

Casual language learners who spend a brief time in another country have different language skill needs than people who become residents of a country that has a different native language than theirs. Foreign residents often need to become proficient in the language of their adopted country in order to work productively, take lecture courses, discuss matters with their colleagues and neighbors, and understand films and television programs. Also, they may wish to reduce their accents and speak like natives.

Travelers often attempt to use phrase books, audio tapes and CDs to learn another language. Phrase books do not teach pronunciation effectively and do not provide listening experience. Audio tapes and CDs overcome those limitations, but do not offer speaking practice with feedback, often focus on vocabulary and grammar rather than practical situations, and tend to be repetitious and boring. Classroom courses are better, but limit personal practice opportunities, require students to spend a great deal of time, and have rigid time schedules.

Several interactive, computer-aided instruction software programs provide more experience and practice with greater flexibility. Some use automatic speech recognition to provide feedback about vocabulary and pronunciation. However, these systems are directed at teaching and measuring the language skills of residents who want to become proficient in a new language, rather than at those who want to learn quickly enough spoken language to accomplish tasks. Thus, these computer software programs emphasize learning and retaining specific vocabularies, improving pronunciation, and reporting detailed measures of language skills. They do not engage learners in realistic dialogues, and most require learners to speak particular words and phrases rather than accepting understandable, but imperfect, speech.

Various prior patents disclose language training systems. U.S. Pat. No. 5,393,236 to Blackmer, et al., discloses an interactive speech pronunciation apparatus and method that teaches pronunciation and accent reduction.

U.S. Pat. No. 5,487,671 to Shapiro, et al., is a computerized system for teaching speech that uses speech recognition and audio measurements and feedback to teach pronunciation, especially accent-free pronunciation.

U.S. Pat. No. 5,540,589 to Waters describes an audio interactive tutor that conducts a dialogue with a learner that is defined by a course of study aimed at increasing the memory retention of spoken responses. It uses speech recognition in a manner that tolerates recognition errors. However, it focuses on memory retention and on repetition to increase retention.

U.S. Pat. No. 5,634,086 to Rtischev, et al., is a recognition and feedback system which provides tracking of learner reading of a script in a quasi-conversational manner for instructing a learner in properly-rendered, native-sounding speech. The learner is presented with a script and speech recognition is used to measure his pronunciation accuracy when reading, then that accuracy is reported.

U.S. Pat. Nos. 5,717,828 and 6,134,529 to Rothenberg disclose speech recognition apparatuses and methods for learning that teach language skills, including vocabulary and pronunciation, present both correct and incorrect responses, present or make available to the learner the correct pronunciation of the responses and the meanings of at least the correct responses, and compare the learner's speech response to internal speech patterns. They require learners to pronounce correctly the correct responses, and do not accept equivalent, understandable responses.

U.S. Pat. No. 5,870,709 to Bernstein describes a method and apparatus for combining information from speech signals for adaptive interaction in teaching and testing language skills through an interactive dialogue where the next prompt presented to a learner is based at least in part on extra-linguist measures (e.g., timing, amplitude and fundamental frequency) of spoken responses to prior prompts. It evaluates the proficiency of learners in skills that can be exhibited through speaking.

U.S. Pat. No. 5,885,083 to Ferrell discloses a system and method for using multimodal interactive speech and language training techniques to train learners to recognize and respond to unfamiliar vocabulary elements by providing preview and recall exercises in which learners are expected to respond within a time period, learners' responses are received and evaluated based on predetermined response criteria, and visual and audio feedback are provided indicating correctness of response where the visual feedback includes an icon and the audio feedback includes a synthesized voice. The Ferrell system does not train learners how to accomplish missions without requiring specific responses or without time limits, and it does not teach culture or simulate a real-world environment.

U.S. Pat. No. 5,393,073 to Best is a talking video game that simulates dialogues between animated characters and between animated characters and human players. It does not teach language, and it does not use speech recognition, but it can simulate highly interactive and enticing, realistic dialogues.

While these prior systems provide certain language training, it is desirable to engage the casual language learner in interesting and realistic dialogues with simulated characters for the purposes of teaching language skills sufficient to successfully accomplish real-world tasks and missions. It is further desirable to teach language listening and speaking skills and to provide for practicing those skills while providing helpful feedback to the learner based on the learner's identified abilities. Additionally, it is desirable to use speech recognition technology in a manner that judges learners' spoken statements to be acceptable if they are both understandable and appropriate for the situation. It is yet further desirable to interactively teach cultural information in conjunction with language interaction.

### SUMMARY OF THE INVENTION

An interactive language learning system embodying the present invention includes a computer system having a central processing unit (CPU) with associated memory and data storage such as hard disc and CD/DVD, at least one input device such as a mouse or trackball, an audio output speaker or headphone, an audio input microphone and a visual display. The system operates by presenting visual images of a simulated village model on the visual display, the image in the model having positional dependence on control through the input device by a learner and the village model including objects and characters. Position induced by the control input is monitored for proximity to a character in the village model and a statement is prompted from the character audible through the audio output means when such proximity is detected. The system then accepts a verbal input from the learner through the audio input.

The verbal input is compared to a set of anticipated learner responses and a skill level of the learner is determined based on an output from the comparison. A character response is then selected based on the skill level of the learner and the character response is presented as an audible statement from the character through the audio output. The visual images of the simulated village model are also monitored for a control input for designation of an object in the model. When such a control input is detected, a selected output is presented in the target language descriptive of the object responsive to a designation. This output is audible through the audio output or visual through a text presentation. An input from the learner can also be provided either audibly or by text entry as a testing mechanism.

In interacting with a character in the system, in addition to prompting an audible statement from the character, the system (in response to a control input) displays the audible statement from the character as text and displays anticipated learner responses also as text.

The system then plays an audio representation of a chosen portion of the character's text responsive to a first control input or an audio representation of a chosen portion of the learner's text responsive to a second control input. The interaction then continues by accepting a verbal input from the learner for the selected response and skill level determination or the system accepts selection of one of the anticipated responses by a control input of the learner, selects a character response based on the selected text response and presents the new character response as an audible statement

### BRIEF DESCRIPTION OF THE DRAWINGS

These and other features and advantages of the present invention will be better understood by reference to the following detailed description when considered in connection with the accompanying drawings wherein:

FIG. 1 is a block diagram illustrating the elements of a computer system that serves as an exemplary platform for the system and methods of the present invention;

FIG. 2 is a block diagram illustrating the software modules employed in an exemplary embodiment of the present invention;

FIG. 3 is a hierarchical depiction of a Learner Database employed in the invention;

FIG. 4 is a hierarchical depiction of an Interaction Database employed in the invention;

FIG. 5 is a flowchart of an enrollment process for the learner;

FIG. 6 is a flowchart for commencement of a learning session;

FIG. 7 is a flowchart for a startup sequence;

FIG. 8 is an exemplary screenshot of the interactive environment through which the learner moves;

FIG. 9a is a flowchart of the interaction sequence for the Visual Dictionary;

FIG. 9b is an exemplary screenshot of the on screen visualizations of the Visual Dictionary elements as generated during the interactions of FIG. 9;

FIG. 10 is a flowchart of a character interaction sequence;

FIG. 11 is an exemplary screenshot of the VoiceBox;

FIGS. 12a, b and c are exemplary branching diagrams for interaction sequences based on learner input and skill level;

FIG. 13a are exemplary skill level tables associated with an interaction node; and,

FIG. 13b is a flow chart of skill level definition within an interaction based on the skill level tables associated with that node.

### DETAILED DESCRIPTION OF THE INVENTION

To be interesting, fun and compelling, a system embodying the invention appears and operates like a computer game. On a computer screen, the language learner is presented with a multimedia, animated, simulated environment in which he may walk down streets, around objects, and into buildings, and may meet and talk with characters, while asking questions and accomplishing such tasks as buying groceries, ordering meals, and learning about the culture presented in the simulated environment.

The simulated environment's appearance is appropriate for the target language, that is, the language that is taught. If the target language is Italian, the learner would see the narrow streets, plastered walls, red tile roofs, piazzas and churches of an Italian town. If the target language is Spanish, the learner might find himself in a simulated Spanish, Mexican or Chilean town. Most, but not necessarily all, simulated characters speak the target language in a dialect that corresponds to their environment. For example, in a simulated Mexican town most characters speak Mexican Spanish, but an occasional visiting character may speak Castilian Spanish or American English.

A human language teacher may configure the invention to lead the learner through a particular sequence of scenarios and missions. Alternatively, the learner may either explicitly select a scenario sequence or simply encounter various situations as he explores the simulation.

In one scenario a Spanish language learner may start at a train station in a Spanish town with the mission of getting something to eat. He walks down a street that leads to a plaza with an arcade and many shops. He notices a fountain, but does not recall the Spanish word for “fountain.” When he points at the fountain, through the use of a Visual Dictionary a narrator's voice says, “fuente.” With button pushes he can hear this again, and also see “fuente” displayed in text on the screen. As he walks along he encounters a young male character who says, “buenas tardes” (good afternoon). The learner responds “hola” (hello) and is pleased that the young man smiles indicating that he understood the learner. Now, remembering that he wants to get something to eat, the learner initiates the following conversation with the young man.

Learner: Perdone. (Excuse me.)

Young Man: Digame? (Yes?)

Learner: Hambre. Se puede ayudarme? (Hungry. Can you help me?)

Young Man (understanding that learner means “Tengo hambre.” (I am hungry.)): Tratase el restaurante alli. (Try the restaurant over there.)

As he speaks, the young man points across the plaza.

Learner (understanding “restaurants” and the pointing): Gracias. (Thank you.)

Young Man (not offended by the casual “gracias” instead of the expected “muchas gracias”): De nada. (My pleasure.)

The learner walks across the plaza to the restaurant. If it is mid afternoon, he discovers that it is closed. When he asks why, the restaurant manager explains that in Spain they close at 2 p.m. so people can take a rest called a siesta, and suggests that the learner return later. If the restaurant is open for lunch or dinner, the learner enters the restaurant, is seated and given a menu, then orders his meal.

Through his responses, the learner directs the conversation and determines subsequent actions. For example, instead of responding “gracias” to the young man the learner might have asked more about the restaurant, or asked about other restaurants or grocery stores. Instead of walking to the restaurant he might have gone elsewhere, for example to a newsstand or post office, and encountered other characters.

If prompted by the learner's skill level or otherwise called during such a conversation, a VoiceBox dialog window appears on the computer screen. By clicking VoiceBox buttons the learner may hear again what the character said, may display the corresponding text in both the target language and the learner's native language, may display text for several alternative appropriate responses in both the target language and his native language, or (if he wants to continue without having to speak this particular response) have the system embodying the invention speak for him.

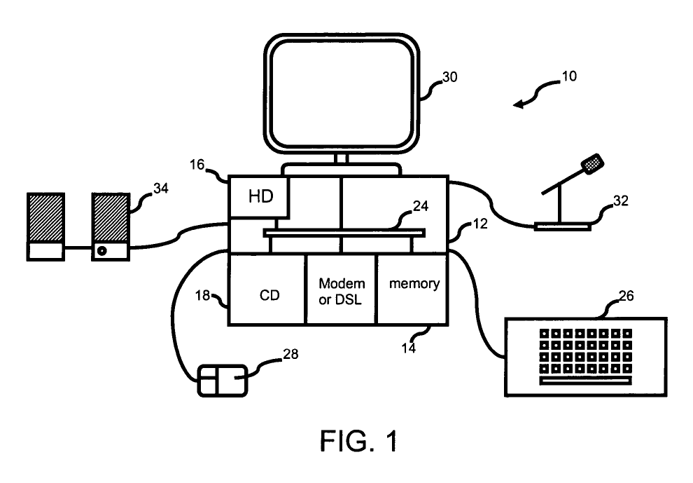

As shown in FIG. 1, computer system 10 comprises a host CPU 12, main memory 14, hard disk drive 16, CD drive 18, audio card 20, and Internet connectivity 22, all of which are coupled together via system bus 24. Some or all of these components can be eliminated or replaced with comparable functional elements in various embodiments of the present invention. Operating system software and other software needed for the operation of the computer system are loaded into the main memory from the hard disk drive upon power up. Some of the code to be executed by the CPU on power up is stored in a ROM or other non-volatile storage device.

At the leaner's request, software that implements this invention is loaded into main memory from the CD drive or Internet connectivity. For the embodiments described herein, the software is created using standard development tools such as C++.

The computer system is further equipped with a conventional keyboard 26 and a cursor positioning device 28 used alone or together for movement control and making selections. In one embodiment, the cursor-positioning device is a mouse; in others it may be a trackball, tablet or other device. In another embodiment, the learner uses voice and speech recognition for movement control and selections.

The computer system further includes a display unit 30, which is coupled to the system bus through display controller, and which displays text and graphical information to the learner. The display may comprise any one of a number of familiar display devices and may be a liquid crystal display unit or video display terminal. It will be appreciated by those skilled in the art, however, that in other embodiments, the display can be any one of a number of other display devices.

To support voice input and output, a standard microphone 32 and a standard speaker 34 are coupled through the audio card. In a preferred embodiment, the microphone is a noise-canceling microphone that provides good response over the 30 Hz to 8000 Hz audio range. In an alternative embodiment, a microphone-headphone headset replaces the microphone and speaker. In an exemplary embodiment, audio card 20 is a Sound Blaster card manufactured by Creative Technology which provides 16-bit audio sampling. In an alternative embodiment, the microphone or headset is a USB microphone or headset that incorporates audio sampling, thus obviating the need for the audio card.

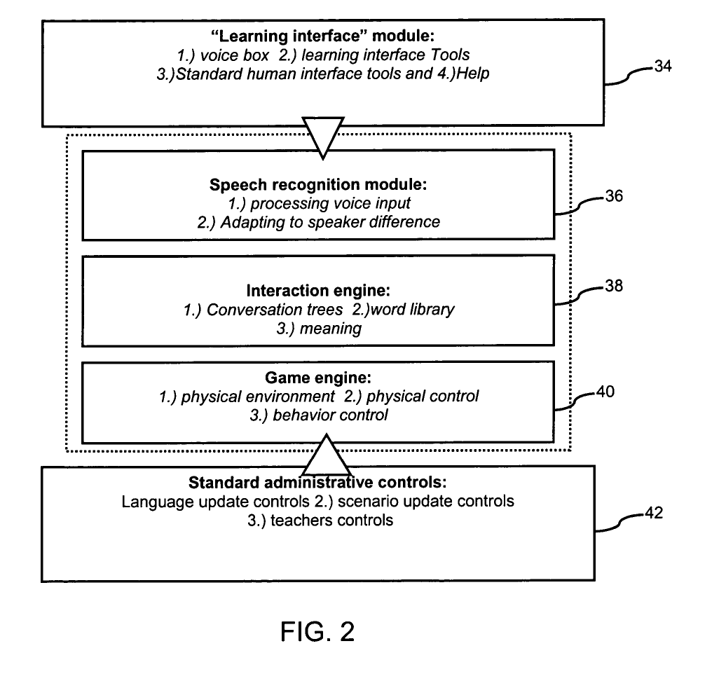

The embodiments of the invention incorporate a plurality of software elements. For description herein as shown in FIG. 2, these elements are identified as: Learning Interface Module 34, Speech Recognition Module 36, Interaction Engine 38, Game Engine 40, and Administrative Controls 42.

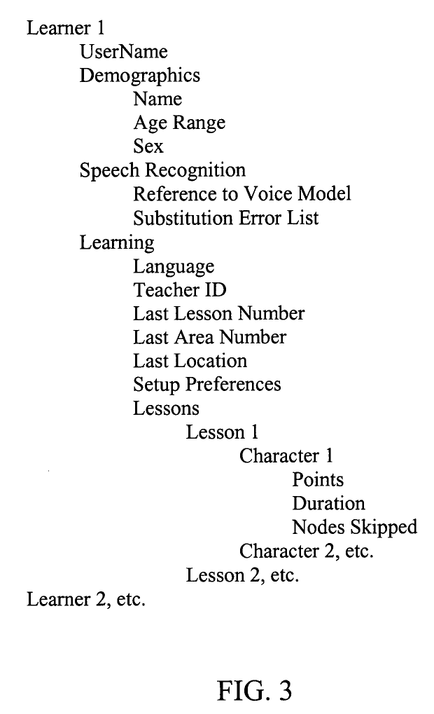

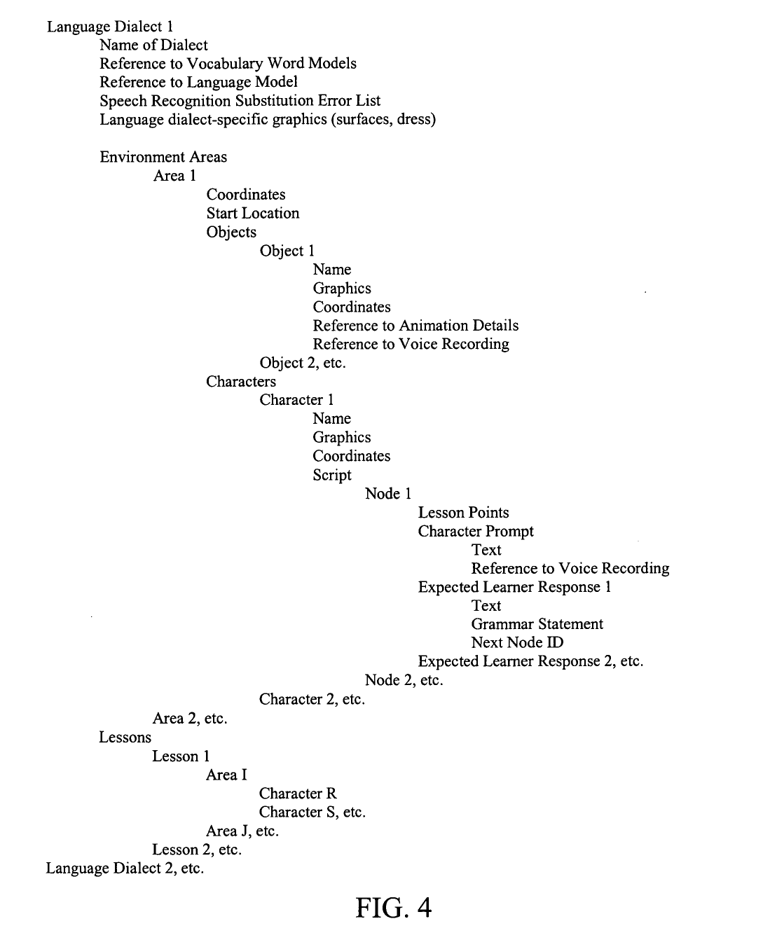

Learning Interface Module 34 loads learner information from a Learner Database shown in hierarchical form in FIG. 3, loads language, environment and lesson information from an Interaction Database shown in hierarchical form in FIG. 4, as the learner moves in the stimulated environment, stores his current location, supports VoiceBox operations, which will be described in greater detail subsequently. The VoiceBox displays characters' and learner's statements in text and plays them in recorded or synthesized voice, it plays in recorded or synthesized voice the names and other information about objects of interest to the learner. The Learning Interface Module records learning information such as what characters the learner conversed with, the learner's success in accomplishing tasks, and how much time he spent, supports standard human interface tools such as positioning device 28, keyboard 26 and microphone 32, and provides, on request, language help information such as abbreviated dictionaries.

The Speech Recognition Module is based on commercially available speech recognition software that processes the learner's voice input and outputs its recognition of the corresponding text. This software is augmented as necessary to recognize words and phrases for the selected language, dialect and scenarios.

The Interaction Engine manages the conversation trees that describe all paths through the learner-character dialogues, selects character prompts, initiates voice output for characters, and interprets the output of the Speech Recognition Module to decide on the next conversation tree node and action. For each language dialect, the Interaction Database stores descriptions of geographical areas that comprise the simulated environment.

The Game Engine presents and manages the simulated physical environment on the computer screen, and controls the behavior of animated characters and other objects as will be described in greater detail subsequently. Each area has boundaries defined by coordinates, a start location where a learner is placed if he enters the area at the start of a lesson, objects such as buildings, mailboxes, fountains, dogs and birds, and characters such as shopkeepers and pedestrians. Some objects are stationary, but others move through the area.

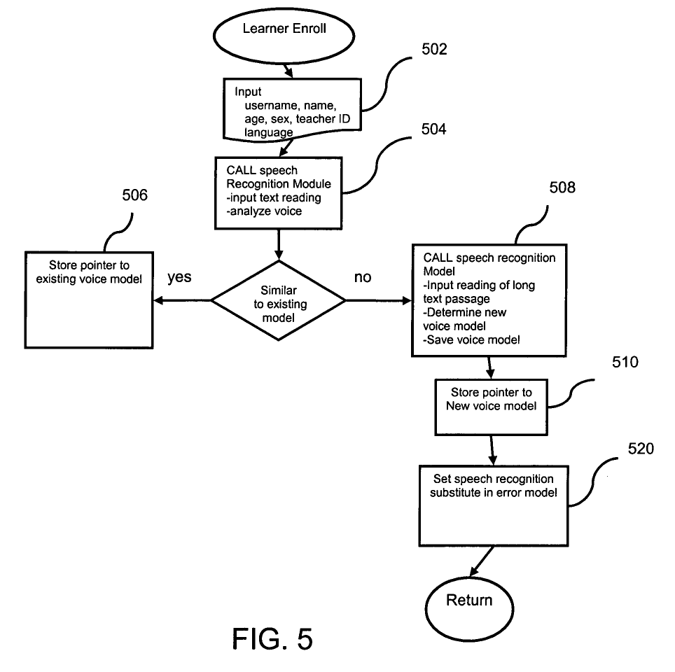

If the learner is new, Learning Interface Module 34 enrolls him using a process as shown in FIG. 5, by obtaining and storing his username, real name, age range, sex, teacher ID, and language choice in step 502. It calls Speech Recognition Module 36 to ask the learner to read a brief text passage, and to analyze the results in step 504. If the learner's voice is similar to that modeled by an existing voice model, it stores a reference to that voice model in step 506. Otherwise, the Learning Interface Module calls the Speech Recognition Module to ask the learner to read a long text passage from which it obtains a voice model for this learner in step 508. A reference to the learner-specific voice model is stored for reference in step 510. A new learner's speech recognition substitution error list is set to the list for the chosen language in step 520.

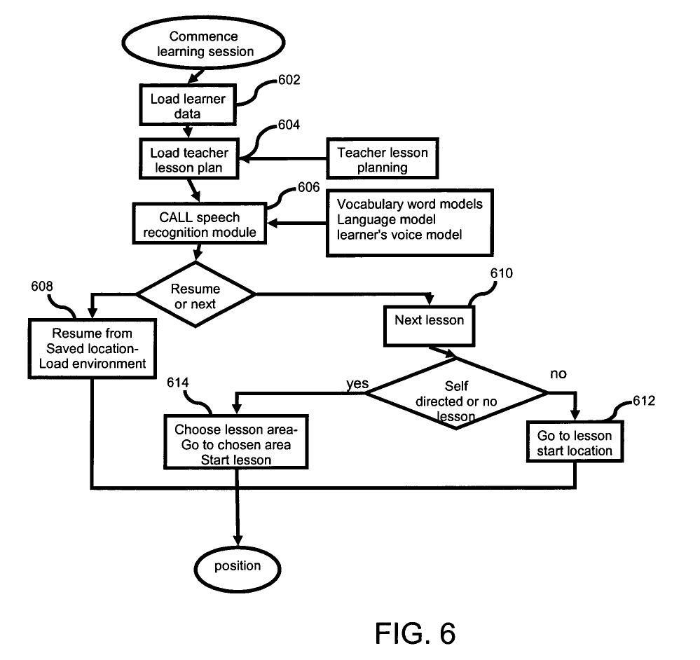

To commence a learning session for an existing, or newly enrolled learner, as shown in FIG. 6, the Learning Interface Module loads the learner's demographic, speech recognition and instruction data in step 602, loads the lesson plan, if input, for the learner's teacher in step 604, and calls the Speech Recognition Module to load the vocabulary word models and language model for the language and also the voice model for the learner in step 606. The learner may either resume from his last lesson and last location in the environment at step 608, or he may start with the next lesson in his teacher's lesson plan at step 610. In the latter case, he is placed at the start location for the first area in the lesson, step 612. If the learner does not have a teacher, or if the teacher's lesson plan indicates “self directed,” the learner may choose an area, and is placed at the start location for that area in step 614.

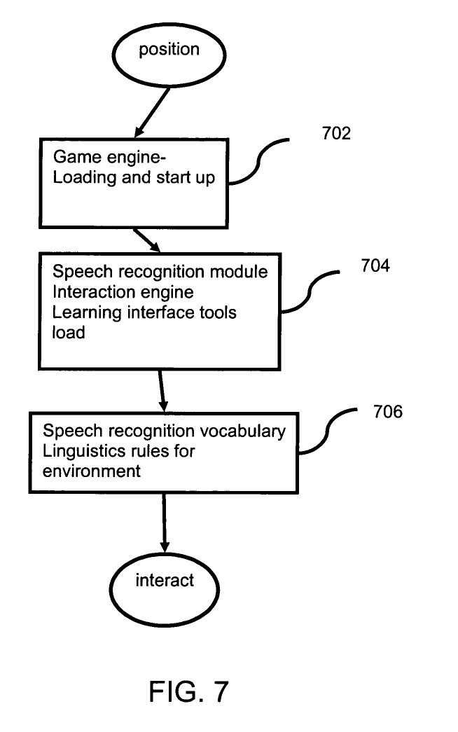

When the learner starts the system embodying the invention and selects a scenario or is directed to one as discussed previously, a shown in FIG. 7, the Game Engine performs its loading and startup sequence 702, and the Speech Recognition Module, Interaction Engine, Learning Interface Module tools are loaded into memory 704 as are the speech recognition vocabulary and linguistic rules appropriate for the scenario 706.

The learner manipulates positioning device 28 to move through the simulated environment. For example, if the positioning device is a mouse in the embodiment, the learner would press the left mouse button to move forward, and alter the position of the mouse to change directions.

As the learner uses a pointing device or voice to move through the simulated physical environment, the Game Engine's position management software renders the associated graphics and sounds. For example, it changes the viewpoint from which fixed objects are seen, it moves objects such as dogs, butterflies and flowing water through the scene, and it plays sounds, such as dog barking.

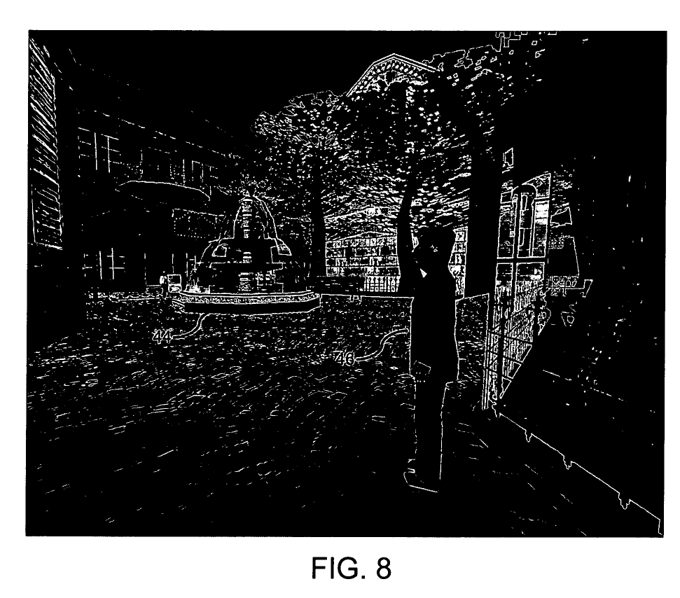

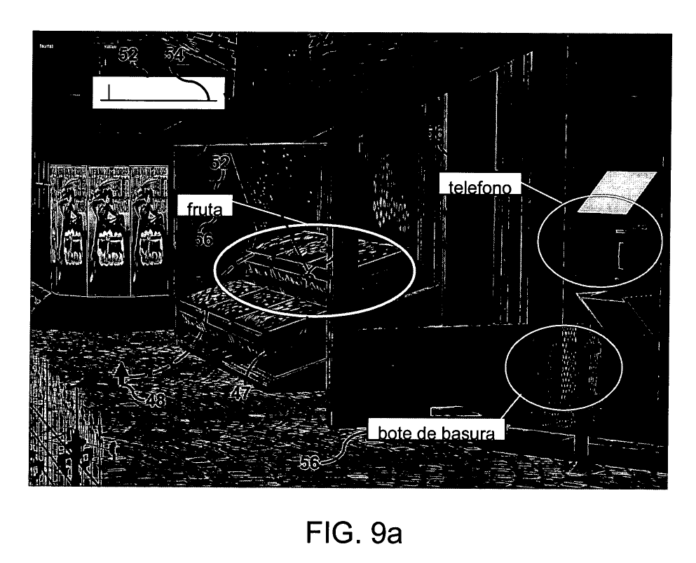

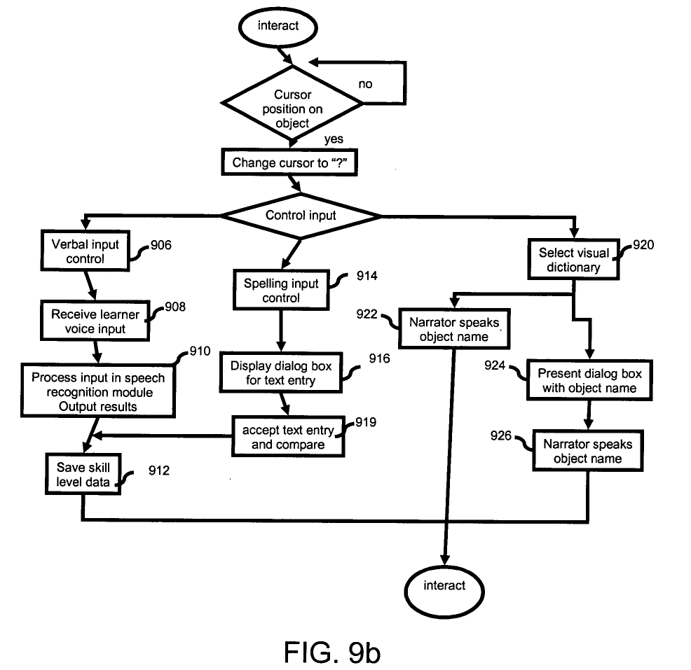

FIG. 8 illustrates a learner's interaction with objects such as a fountain 44 and characters such as passerby 46 as he moves through an area. The Game Engine tracks the learner's location in the area, and compares that with object and character boundaries. When the learner is proximate an object and points to it with positioning device, the Visual Dictionary is launched. For the embodiment described herein the Visual Dictionary provides both “test” and “help” functionality. Three levels of interaction are available; Point and Speak, Point and Spell and Dictionary. FIG. 9a shows the event sequence while FIG. 9b shows the screen appearance elements.

When the learner points to an object, identified for purposes of description by a “hotspot” shown in the drawing as circle 47, in step 902, the screen pointer changes from an arrow 48 to a question mark 50, as indicated in step 904. Upon clicking a control on the pointing device or a designated key, step 906, the learner may say the object's name in step 908, and then receive feedback about whether he said the object's name correctly in step 910. Speech Recognition Module 36 is used for this purpose. Additionally, the proficiency of the learner is cued from the response for rating the learner in step 912 as will be described in greater detail subsequently. Alternatively, upon clicking an alternate control, step 914, on the pointing device or if otherwise selected in the lesson plan, a dialog box 52 with an entry input 54 is presented. Step 916, in which the learner types a response, spelling the name of the object, step 918. In FIG. 9b the various elements of the Visual Dictionary presentation on the screen are all shown simultaneously for simplicity while it is understood that individual elements only are presented when pointed, clicked or selected as described above.

If the Dictionary element is desired, upon clicking a selected control on the pointing device or designated key, step 920, the learner hears the name of the object spoken by the narrator in step 922 or sees a dialog box 56 with the spelling of the object's name, step 924, and a further control button to be clicked to hear the narrator pronounce the name, step 926. For example, in one embodiment the learner may click the left mouse button of positioning device 28 to have the object's name spoken, but click the right mouse button to say its name.

In one embodiment, the Learning Interface Module causes the stored voice recording of the object's name to play through the audio card and speaker. In another embodiment, the Learning Interface Module sends the text for the object's name to a text-to-speech synthesis module, which generates speech that is played through the audio card and speaker.

An exemplary software routine for implementing the sequence of FIG. 9a is shown in Table 1.

```
TABLE 1
// If the mouseIcon is in dictionary mode then get the object
If (mouseIcon == DictionaryMode)
    // Get the object select by the mouse
    object = getObject( )
    // If we are in speak mode then get the learner input and determine
    // the response level. Output the response level to the learner.
    If ( mode == SpeakMode)
        Input = getLearnerInput( )
        ResponseSkillLevel = analyzeLearnerInput(object)
        outputResponseLevel(responseSkillLevel)
    // If we are in spell mode then launch a spell window so the learner
    // can input the text. Analyze the input and output the response level.
    Else if ( mode == spellMode )
        LauchSpellWindow( )
        Input = getLearnerInput( )
        ResponseSkillLevel = analyzeLearnerInput(object)
        outputResponseLevel( responseSkillLevel)
    // If we are in visual dictionary mode then output the audio
    // of the object and launch the spell window with the objects text.
    else if ( mode = VisualDictionary )
        playObjectName(object)
        launchSpellWindow(object)
```

Similarly, when the learner moves close to a character, he may have a conversation with the character under control of Interaction Engine 38. The character's speech may be generated either with a voice recording or through use of a text-to-speech synthesis module, depending on the embodiment. Speech Recognition Module 36 recognizes the learner's verbal responses.

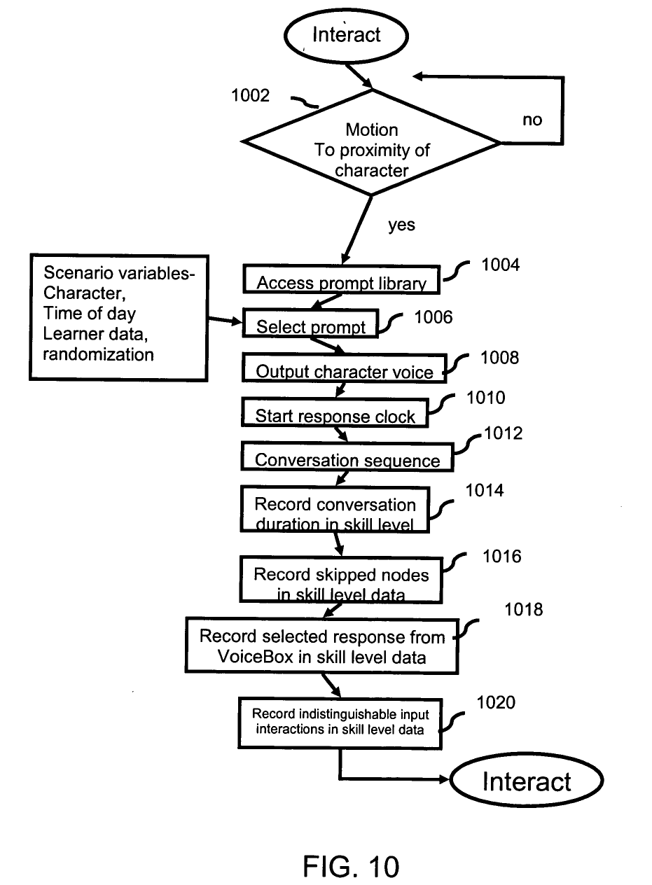

As shown in FIG. 10, when the learner enters the proximity of a character as detected by the Game Engine, step 1002, the invention accesses a prompt library for that particular character, step 1004. The Interaction Engine Prompt Selector selects the specific prompt based on scenario variables such as what other characters the learner has encountered already and the simulated time of day, the learner's age and sex, and, for variability, randomization in step 1006. In the embodiment shown, the Interaction Engine locates the character's voice recording for the selected prompt, step 1008. Alternatively, it synthesizes the voice from the prompt text. The Learning Interface Module then delivers the corresponding sound through the audio card and speaker to the learner.

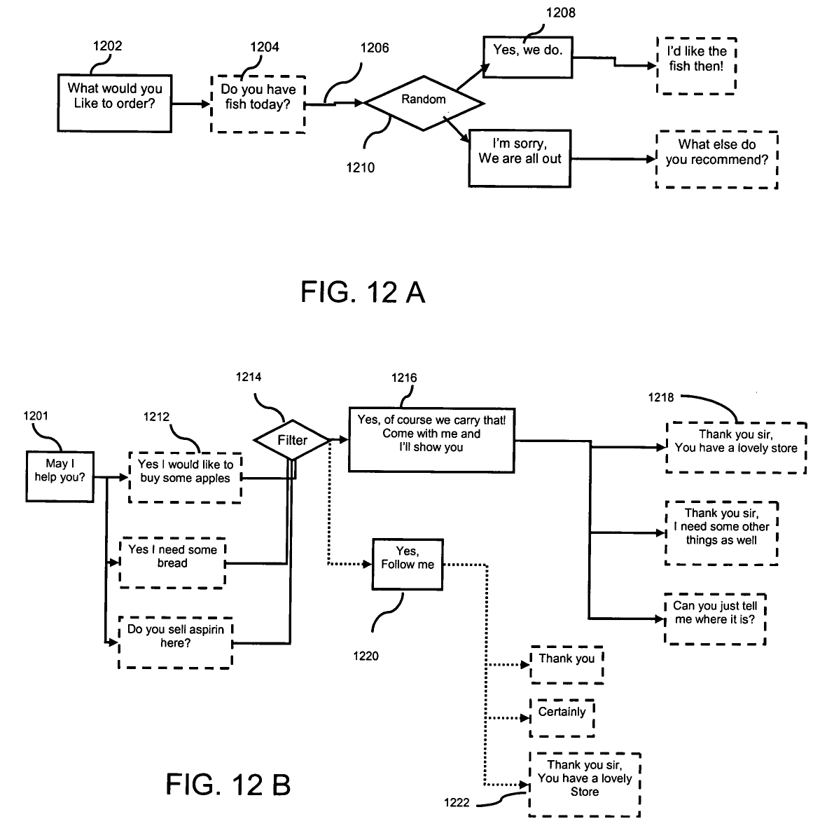

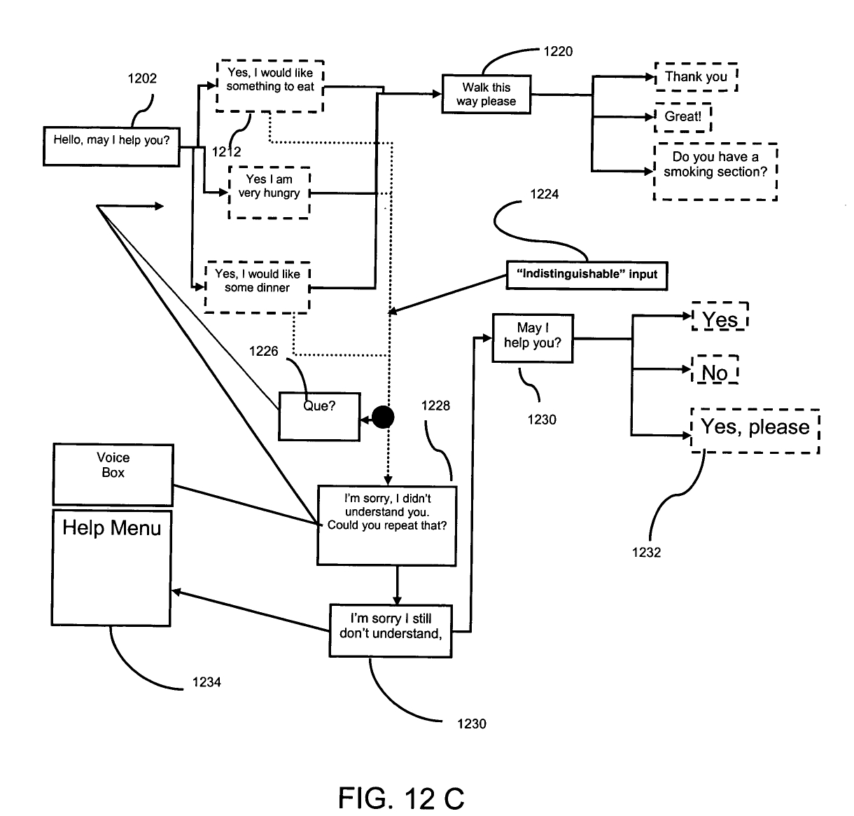

For the purposes of providing feedback to learners and their teachers, the Learning Interface Module records in the Learner Database information about learner-character conversations. A learner is given lesson points for each node he reaches in a character's script. The number of points is substantial when the learner completes a task, e.g., as indicated by reaching a “thank you for ordering a meal” node. Also, the Learning Interface Module stores temporarily the starting clock time for a conversation in step 1010, then records in the Learner Database the conversation duration at the end of the conversation in step 1014. The conversation sequence, which will be described in greater detail with respect to FIGS. 12a, b and c, is designated generally as step 1012. In addition, the Learning Interface Module records any skipped conversation nodes step 1016, nodes where the learner selected a response from the VoiceBox, step 1018, and changes in skill level required by the learner making an indistinguishable input in step 1020.

During conversations Interaction Engine 38 provides likely speech recognition errors to Learning Interface Module 34. For example, when one of the alternative learner responses includes “hambre,” but the Speech Recognition Module recognizes “hombre,” The Interaction Engine sends this likely speech recognition substitution error to the Learning Interface Module, which stores this error in the Learner Database for the purpose of improving speech recognition. In one embodiment a recording of the misrecognized learner's response is stored also.

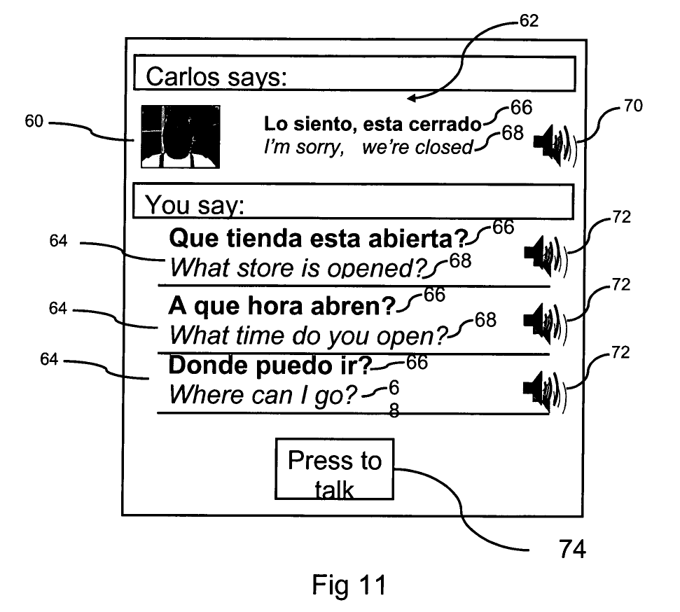

In certain modes of operation of the embodiment when a learner attempts to name an object, or has a conversation with a character, the Learning Interface Module displays the VoiceBox. In the embodiment presented herein, the VoiceBox is a window on the computer monitor that, for a character interaction, shows an image that represents the character, text for the character's prompt in both the learner's language and the target language, alternative texts for possible learner's responses in both the learner's language and the target language, and several software buttons. FIG. 11 illustrates one embodiment of the Voicebox. The Voicebox includes an icon representing the character 60 with whom the interaction is taking place. Text based interaction aids help the learner to understand the character, and to know what to say. Which, if any, texts are displayed depend on setup preferences stored in the Learner Database which may be modified dynamically based on the skill level. Texts available include the statement/question by the character 62, the possible responses by the learner to the character's statement/question 64. Alternatively, the texts include the foreign language phrases 66 only for advanced learners or include native language interpretive texts 68 for less advanced learners. The presentation of native language interpretive texts can be toggled on and off using a control key or automatically by skill level.

Audio interaction aids are provided using Voicebox buttons, the learner may repeatedly replay the character's voice prompt using button 70 (shaped as a speaker for easy recognition) and may repeatedly play the voice for any alternative learner response using buttons 72. In certain embodiments, by clicking on the individual words of the texts, the word is played as opposed to the entire phrase. To make a verbal response, the learner clicks on the “Press to Talk” button 74 and speaks his response into the microphone. If the learner's own voice response is not recognized successfully, he may skip the node by choosing a listed alternative response as his own, for example double clicking on the text of the selected response, which will cause the Interaction Engine to advance to the next node in the conversation script.

When the learner “speaks” by playing a listed response, the corresponding text is passed to the Interaction Engine. If he responds verbally, the text recognized by the Speech Recognition Module is passed to the Interaction Engine. In the preferred embodiment the Speech Recognition Module outputs more than one alternative recognized text, with the alternatives ranked or scored. For example, the Speech Recognition Module may output the alternatives “hombre” and “hambre” where the first result is more likely. Alternatively, the Speech Recognition Module provides only one text, for example, “hombre.” The Interaction Engine applies linguistic rules specific to the particular node in the conversation tree. For example, in the conversation between the learner and the young man, the learner might be expected to say something like “Donde puedo comprar alguna comida?” (Could you tell me where I can find some food?), or something like “Tengo hambre. Se puede ayudarme?” (I am hungry. Can you help me?). Because “hombre” is known, according to the linguistic rules, to be a likely misrecognition of “hambre” and the latter is a key word in the second expected response, that response is chosen as an acceptable response from the learner. When the Interaction Engine does not find an acceptable learner response, it causes the character to speak in the target language one of several alternative statements like “I'm sorry, but I don't understand.” In that case the scenario remains at the same node in the conversation tree.

The interaction of the learner and the character and rating of the skill level of the learner are based on branching paths. In general, three categories of input by the learner are accommodated.

The first category is characterized as “Well-formed” input (implies learner is comfortable with the content) as shown in FIG. 12a. In the case that upon hearing a question/statement 1202 from the character the learner supplies an exact response/input 1204 for the scenario with the correct pronunciation and accent, the interaction will proceed along the branch 1206 which allows multiple character responses 1208, and where all contextual variables are equal, a random number generator 1210 will pick the character response.

Until given input to contradict this category definition, the system will move the learner along the branch to reach an appropriate balance of comfort and “practice required.”

A response characterized as a “Partial input” as shown in FIG. 12b implies the learner needs help. In the case that the learner supplies a partial response/input to the character, as previously described in the example for “hambre,” the game will interpret the response using a filter 1214 according to a literal interpretation of the meaning of the word. For example, hambre =hungry, which the character will interpret as a statement “I am hungry”. The character will respond to clarify “You are hungry?”, step 1216, to which the learner may again provide multiple responses 1218. Alternatively, the character may infer the character's intent—hungry means “Can you tell me where to find food?” and “hambre” may elicit the response 1220, “You are hungry? There is a restaurant across the plaza?” Again the learner may provide one of multiple responses 1222.

This response will cause the content and skill level of the interaction to either hold constant (keeping the learner in scenarios with similar content to ensure the appropriate amount of practice) or decrease in skill level. This category of input may also trigger the VoiceBox, described previously, as a learning aid.

For a response characterized as “Indistinguishable” input, shown in FIG. 12c, the case in which none of the learner's input is recognizable as determined in step 1224, the character(s) in the interaction will respond with a variation on the typical response (Excuse me? In English, or Que? In Spanish) 1226.

The anticipated response from the learner is positioned back to the previous choices 1212. This takes into account possible input (mic) errors, and gives the learner a second chance before the game defaults to an easier level. If the response is indistinguishable for a second time, the system will prompt a character response 1228 such as “I'm sorry I still don't understand” and will default to an easier dialog level prompting a statement/question 1230 from the character having less sophistication that will allow a series of answers 1232 as anticipated from the learner. The anticipated responses 1232 would be simpler for the learner to produce and easier for the Speech Recognition Module to recognize and process. This response will trigger a help menu 1234 such as the VoiceBox previously described as an aid for the learner.

Exemplary code for accomplishing the branching elements during a learner's interaction with a character are shown in Table 2

```
TABLE 2
// Retrieve user voice input
input = getUserInput( )
// Analyze the user input to determine the skill level of the response
responseSkillLevel = analyzeResponeLevel(input)
// Point A
// If the response is current then continue at the same skill level
If (responseSkillLevel == ExpertRespone)
    enableVoiceBox = FALSE;
// Point B
// If the response is partially correct then determine if the skill level
// should be adjusted and determine if the voice box needs to be launched.
else if (responseSkillLevel == PartialResponse)
    skillLevel = adjustSkillLevel(responseSkillLevel)
    // Point C
    If (triggerVoiceBox)
      enableVoiceBox = TRUE;
// Point D
// If the response was invalid then adjust the skill level and launch the
voice box.
else if (responseSkillLevel == InvalidResponse)
    skillLevel = adjustSkillLevel( responseSkillLevel)
    // Point C
    enableVoiceBox = TRUE;
If (enableVoiceBox)
    launchVoiceBox( );
        outputNextCharacterResponse(skillLevel);
```

If the learner's response is acceptable, it triggers a character action and response. Depending on the learner's response, the Interaction Engine moves to another conversation tree node. Typically the Interaction Engine sends behavior instructions to the Game Engine, which again renders appropriate graphics and sound for the new node. The Prompt Selector selects a specific prompt based on scenario variables. Then the Learning Interface Module delivers the corresponding sound to the learner. If the conversation between the learner and this character has concluded, the Interaction Engine calls upon the Game Engine to render graphics and sound, but no character prompt is spoken until the learner enters the proximity of another character.

The learner continues in this manner until he completes his task or wishes to stop for some other reason. During the scenario the Learning Interface Module tracks and records the learner's activities and performance, and makes that information available for review. Later, using information stored by the Learning Interface Module, he may resume from the most recent conversation tree node. This Save Your Place feature in the learning Interface Module provides that when a learner leaves the world they were operating in, they may want to pick up where they left off—repeating everything they have already done in a level may be an annoying turn off. In addition, however, it is not desirable to lose the value of the connection to the game the learner has created.

This context includes the user's “grade” (or state); in other words, the data that describes how successful the user has been in various interactions, what words they had difficulty with, etc., user variables that might be stored, i.e. items purchased. In particular, by creating a construct in which a learner is associated with a particular level of proficiency, which is in turn associated with vocabulary, the game can introduce scenarios using those words the user is having trouble with so that they can practice. Finally, information on the level “state” is saved. What has occurred in the level? Where has the learner been, and what objects/characters are in a different state as a result? A relevant object state change might be a door left open, or a beverage purchased.

A relevant character state change might be a person already interacted with, who will remember the learner. The characters in the embodiment of the invention and the scenarios presented have a “memory,” just as they do in real life. If the learner entered a cafe, ordered a cup of coffee, and sat in the square—then came back again 15 minutes later, the barista would remember learner, and probably say, “Back again? Would you like another coffee?”

Once in a given instance of the presentation by the system (i.e. a particular general skill level), each interaction provides the opportunity for assessment of skill level. In aggregate, all interactions provide a growing pool of information from which to make better assessments of the learner's skill level.

Prior to any potential interaction, the system holds information on the user's skill level, and uses that information (vocabulary skill level, pronunciation skill level, syntax skill level, speed of speech skill level) to determine which options the learner will be presented with. Variables such as vocabularySkillLevel are stored in the database, and integrated with other variables such as speedOfSpeech to determine which interactions are best suited to the learner's level, and how those interactions should be assessed.

Once the user chooses an interaction, and begins to either initiate interactions or respond to interactions, variables are updated as means of past performance measurement to ensure that ‘outliers’ are eventually be thrown out, and the system will target the learner's true skill level over time.

At the completion of the interaction (or during the interaction, as a native speaker would), the game ‘adjusts’ to the new information regarding the learner's skill level by presenting either new options within an interaction (the equivalent of a native speaker spewing out a question at the learner at full tilt, then realizing by the learner's speed of speech and vocabulary that he/she is less skilled and proceeding to speak slowly with small words) as described previously with respect to FIGS. 12a-c, or with different interactions (the equivalent of a passer by recognizing the learner is still learning, and engaging the learner with appropriate topics and language).

For the embodiment disclosed herein, the system employs three categories of criteria for establishing the interaction level, comprehension, production and help used. The comprehension element evaluates the learner's vocabulary knowledge, i.e. a percentage of correct words used in responses to the Visual Dictionary as described above and comprehension test scores, i.e. responses to the voice box or character speech without native language text presentation. The production element evaluates the speed of the learner's speech using a timer initiated by the voice recognition module when receiving voice input and stopped at the conclusion of speech input, the response rate, i.e. the number of correct words in the response (as described with respect to fluent vs. partial responses above), and production test scores, i.e. response to character questions/statements without the voice box or without voice box presentation of the response list. Finally, the help used assessment measures how often the learner has called the VoiceBox and what level of assistance, i.e. character statement only in target language, addition of character statement in native language, addition of response list, etc.

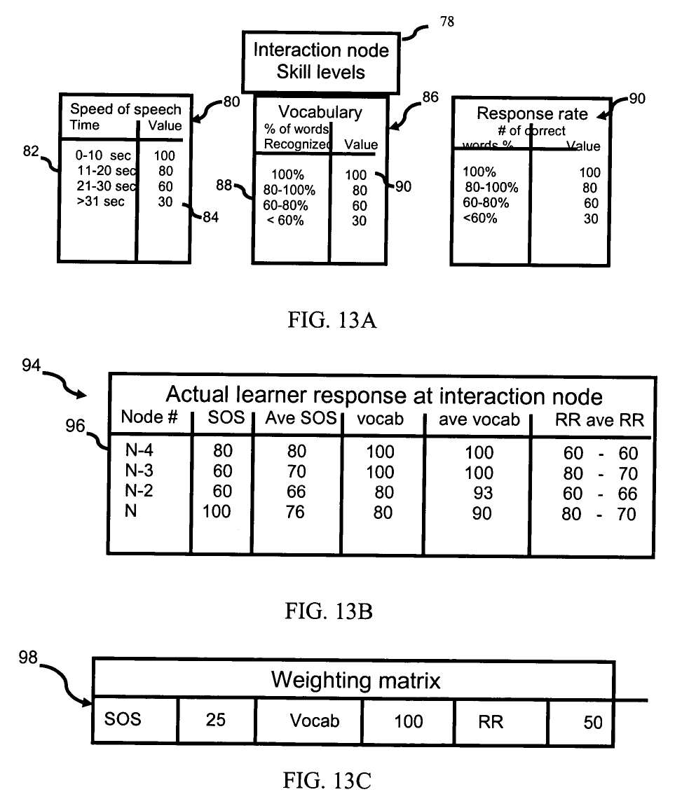

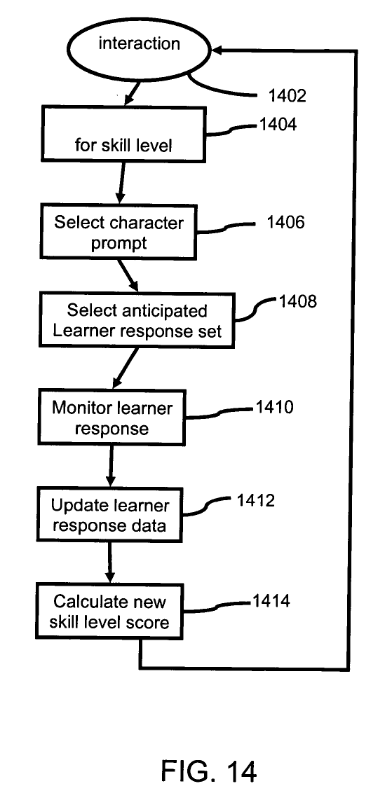

A matrix, as shown in FIG. 13, is established using the elements described to provide a rated score used for selection of character interaction trees. A weighting is applied to the raw data for each element based on the interaction level chosen by the learner upon initiating the session, i.e. beginner, intermediate or advanced. For the example shown in the drawings, a speed of speech (SoS) table 80 is defined for the interaction node 78 by a defined time for the response 82 (in the embodiment shown a set of ranges) and a value 84 associated with each range. Similarly, a Vocabulary table 86 is maintained for recognition of character speech having a parameter established by a percentage of the number of words recognized 88 corresponding to a second value 90. Finally, a recognition rate (RR) table 92 also defines a parameter based on a percentage of the number of words.

A table of actual learner response 94, which for the embodiment shown tracks the five most recent interaction nodes 96 and averages the results, is then used in conjunction with a weighting matrix 98 to provide a skill level score. In this example the weighting matrix gives a higher weight 100 to the vocabulary while the SoS and RR data are weighted at a lower values of 25 and 50 respectively. The weights merely indicate a relative value of the importance of the various elements making up the skill index. Typically, these weights are defined by the teacher based on assessment of skill improvement required and entered as a portion of the lesson data as described above with respect to FIG. 6. The weights may be established as a percentage totaling 100% however, the calculation is not affected.

Calculation of the skill level score is accomplished using equation 1.
score=SoSTableValue*SoSWeight+Vocab % score*VocabWeight+RRTable Value *RRWeight (1)

A perfect score would be 100*25%+100*100%+100*50%=175

The actual score based on the data in table 94 is 76*25%+90*100%+70*50%=144.

The skill level is established by dividing the actual weighted score by the potential perfect score or 144/175=0.82. This skill level then defines the selection of character prompts and anticipated responses at the next interaction node. For example the selection of character responses 1208 and the following learner anticipated responses 1214 in FIG. 12a would be determined with any skill level score over 0.5 resulting in selection of the upper prompt. The two prompt choice levels in FIG. 12a is a simplistic model and multiple prompt trees can be provided for greater scaling based on the skill level score. Further, in alternative embodiments, the character prompt and learner anticipated responses are decoupled based on individual skill element scores. As an example, a learner with a high vocabulary score is able to react to more complex speech from the character. However, if the learners SoS or RR scores are lower, simpler anticipated responses are provided.

As previously described, the VoiceBox may be initiated based on the skill level score to automatically begin appearing if the skill level score drops below a predefined value. Additionally, learner selection of the VoiceBox prior to response and use of selected response in the VoiceBox to pass the node are entered into the Actual Learner Response Table as a lower score to appropriately affect the averages.

FIG. 14 provides an exemplary process flow for selection of the character statement/question initiating an interaction or responding to a learner input. The Interaction Engine identifies the beginning of an interaction, step 1402, and queries the skill matrix from the prior node for a level determination, step 1404. Based on the level determination, the character statement /question is determined, step 1406, and the response set for the learner defined, step 1408. The actual response by the learner, step 1410, will then alter the character response tree selection as previously described with respect to FIGS. 12a-c. At the conclusion of the exchange in the interaction as determined by the Interaction Engine, the additional skill level data for comprehension, production and help used, are added to the database, step 1412, and the matrix recalculated, step 1414, in preparation for the next interaction.

Having now described the invention in detail as required by the patent statutes, those skilled in the art will recognize modifications and substitutions to the specific embodiments disclosed herein. Such modifications are within the scope and intent of the present invention as defined in the following claims.

1. An interactive language learning system comprising:
a computer system having a central processing unit (CPU) with associated memory and storage means, at least one input device, audio output means, audio input means and means for visual display;
means for presenting visual images of a simulated village model on the visual display, the image in the model having positional dependence on control through the input device by a learner, the village model including objects and characters;
means for monitoring position induced by the control input for proximity to a character in the village model;
means for prompting a statement from the character audible through the audio output means;
means for accepting a verbal input from the learner through the audio input means;
means for comparing the verbal input to a set of anticipated learner responses;
means for determining a skill level of the learner based on an output from the comparing means;
means for selecting a new character response based on the skill level of the learner; and,
means for presenting the new character response as an audible statement from the character through the audio output means.

2. An interactive language learning system as defined in claim 1 further comprising
means for monitoring the control input for designation of an object in the model; and,
means for providing a selected output in the target language descriptive of the object responsive to a designation.

3. An interactive learning system as defined in claim 2 wherein the selected output is an audible verbalization of the name of the object in the target language through the audio output means.

4. An interactive learning system as defined in claim 2 wherein the selected output is a text display of the name of the object in the target language.

5. An interactive learning system as defined in claim 4 further comprising:
means for monitoring for an additional control input; and
means for providing an audible verbal output of the name of the object displayed in the text.

6. An interactive learning system as defined in claim 2 wherein the selected output is a text input box displayed on the display and further comprising:
means for accepting a text input by the learner into the input box;
means for comparing the text input to the target language name of the object; and means for determining a skill level of the learner based on the comparison.

7. An interactive learning system as defined in claim 1 further comprising:
means for displaying the audible statement from the character as first text; and,
means for displaying anticipated learner responses as second text.

8. An interactive learning system as defined in claim 7 further comprising:
means for accepting selection of the second text of one of the anticipated responses by a control input of the learner;
means for selecting a new character response based on the selected text response; and,
means for presenting the new character response as an audible statement from the character.

9. An interactive language learning system comprising:
a computer system having a display;
means for presenting visual images of a simulated village model on the display having positional dependence on a control input from a learner, the village model including objects and characters;
means for monitoring position induced by the control input;
means for monitoring the control input for designation of an object in the model; and,
means for providing a selected output in the target language descriptive of the object responsive to a designation.

10. An interactive language learning system as defined in claim 9 wherein the computer system includes audio output means and the selected output is an audible verbalization of the name of the object in the target language.

11. An interactive language learning system as defined in claim 9 wherein the selected output is a text display of the name of the object in the target language.

12. An interactive language learning system as defined in claim 11 wherein the computer system includes audio output means and further comprising:
means for monitoring for an additional control input; and
means for providing an audible verbal output of the name of the object displayed in the text.

13. An interactive language learning system as defined in claim 9 wherein the selected output is a text input box displayed on the display and further comprising:
means for accepting a text input by the learner into the input box;
means for comparing the text input to the target language name of the object; and
means for determining a skill level of the learner based on the comparison.

14. An interactive language learning system as defined in claim 9 wherein the selected output is a question mark displayed on the display and further comprising:
means for accepting a verbal input by the learner;
means for comparing the verbal input to the target language name of the object; and
means for determining skill level of the learner based on the comparison.

15. An interactive language learning system comprising
a computer system having control input means, a display, audio input means and audio output means;
means for presenting visual images of a simulated village model on the display having positional dependence on a control input from a learner, the village model including objects and characters;
means for monitoring position induced by the control input for proximity to a character in the village model;
means for prompting an audible statement from the character responsive to the monitoring means;
means for displaying the audible statement from the character as first text; and,
means for displaying anticipated learner responses as second text.

16. An interactive language learning system as defined in claim 15 further comprising a means for playing an audio representation of a chosen portion of the first text responsive to a first control input and means for playing an audio representation of a chosen portion of the second text responsive to a second control input

17. An interactive language learning system as defined in claim 15 further comprising:
means for accepting a verbal input from the learner;
means for comparing the verbal input to a set of anticipated learner responses;
means for determining a skill level of the learner based on the comparison;
means for selecting a new character response based on the skill level of the learner; and,
means for presenting the new character response as an audible statement from the character.

18. An interactive language learning system as defined in claim 15 further comprising:
means for accepting selection of the second text of one of the anticipated responses by a control input of the learner;
means for selecting a new character response based on the selected text response; and,
means for presenting the new character response as an audible statement from the character.

19. An interactive language instruction system as defined in claim 1 further comprising means for determining a base skill level and wherein said prompting means selects the statement for the character responsive to the base skill level determined.

20. An interactive language instruction system as defined in claim 19 wherein the means for determining a base skill level comprises means for measuring response time of the verbal input received by the accepting means.

21. An interactive language instruction system as defined in claim 19 wherein the means for determining a base skill level comprises means for establishing a response rate based on a proportion of the number of correct words from a nearest one of the anticipated learner responses present in the verbal input from the learner.

22. An interactive language instruction system as defined in claim 19 wherein the means for determining a base skill level comprises means for establishing vocabulary knowledge of the learner.

23. An interactive language instruction system as defined in claim 19 wherein the means for determining a base skill level comprises:
means for measuring response time of the verbal input received by the accepting means;
means for establishing a response rate based on a proportion of the number of correct words from a nearest one of the anticipated learner responses present in the verbal input from the learner;
means for establishing vocabulary knowledge of the learner; and
means for establishing a skill level score using weighted values from the means for measuring response time, means for establishing a response rate and means for establishing vocabulary knowledge.

24. A method for interactive language instruction on a computer system comprising the steps of:
presenting visual images of a simulated village model having positional dependence on control input from a learner, the village model including objects and characters;
monitoring position induced by the control input for proximity to a character in the village model;
prompting an audible statement from the character;
accepting a verbal input from the learner;
comparing the verbal input to a set of anticipated learner responses;
determining a skill level of the learner based on the comparison;
selecting a character response based on the skill level of the learner; and,
presenting the character response as an audible statement from the character.

25. A method as defined in claim 24 further comprising the steps of:
monitoring the control input for designation of an object in the model; and,
providing a selected output in the target language descriptive of the object responsive to a designation.

26. A method as defined in claim 25 wherein the selected output is an audible verbalization of the name of the object in the target language through the audio output means.

27. A method as defined in claim 25 wherein the selected output is a text display of the name of the object in the target language.

28. A method as defined in claim 27 further comprising the steps of:
monitoring for an additional control input; and
providing an audible verbal output of the name of the object displayed in the text.

29. A method as defined in claim 25 wherein the selected output is a text input box displayed on the display and further comprising the steps of:
accepting a text input by the learner into the input box;
comparing the text input to the target language name of the object; and
determining a skill level of the learner based on the comparison.

30. A method as defined claim 24 further comprising the steps of:
displaying the audible statement from the character as first text; and,
displaying anticipated learner responses as second text.

31. A method as defined claim 30 further comprising the steps of:
accepting selection of the second text of one of the anticipated responses by a control input of the learner;
selecting a new character response based on the selected text response; and,
presenting the new character response as an audible statement from the character.

32. A method for interactive language instruction on a computer system comprising the steps of:
presenting visual images of a simulated village model having positional dependence on control input from a learner, the village model including objects and characters;
monitoring position induced by the control input;
monitoring the control input for designation of an object in the model; and,
providing a selected output in the target language descriptive of the object responsive to a designation.

33. A method as described in claim 32 wherein the selected output is an audible verbalization of the name of the object in the target language.

34. A method as described in claim 32 wherein the selected output is a text display of the name of the object in the target language.

35. A method as described in claim 34 further comprising the steps of:
monitoring for an additional control input; and
providing an audible verbal output of the name of the object displayed in the text.

36. A method as described in claim 32 wherein the selected output is an input box and further comprising the steps of:
accepting a text input by the learner into the input box;
comparing the text input to the target language name of the object; and
determining a skill level of the learner based on the comparison.

37. A method for interactive language instruction on a computer system comprising the steps of:
presenting visual images of a simulated village model having positional dependence on control input from a learner, the village model including objects and characters;
monitoring position induced by the control input for proximity to a character in the village model;
prompting an audible statement from the character;
displaying the audible statement from the character as first text; and,
displaying anticipated learner responses as second text.

38. A method as described in claim 37 further comprising the step of playing an audio representation of a chosen portion of the first text responsive to a first control input and playing an audio representation of a chosen portion of the second text responsive to a second control input

39. A method as described in claim 37 further comprising the steps of:
accepting a verbal input from the learner;
comparing the verbal input to a set of anticipated learner responses;
determining a skill level of the learner based on the comparison;
selecting a character response based on the skill level of the learner; and,
presenting the character response as an audible statement from the character.

40. A method as described in claim 37 further comprising the steps of:
accepting selection of the second text of one of the anticipated responses by a control input of the learner;
selecting a character response based on the selected text response; and,
presenting the character response as an audible statement from the character.

41. A method as described in claim 24 wherein the step of determining a skill level further comprises the steps of:
determining a base skill level and wherein said step of prompting selects the statement for the character responsive to the base skill level determined.

42. A method as defined in claim 41 wherein the step of determining a base skill level comprises measuring response time of the verbal input received by the accepting means.

43. A method as defined in claim 42 wherein the step of determining a base skill level further comprises the step of establishing a response rate based on a proportion of the number of correct words from the nearest of the anticipated learner responses present in the verbal input from the learner.
